(19) United States
(12) Patent Application Publication
(10) Pub. No.: US 2013/0304401 A1
(43) Pub. Date: Nov. 14, 2013

(54) APPARATUS AND METHOD FOR LOCATING THE POINT OF IMPACT OF A BODY ON A SURFACE

(71) Applicants: Stefano Tubaro, Novara (IT); Angusto Sarti, Seregno (IT); Marco Tagliasacchi, Carate Urio (IT); Fabio Antonacci, Ponte Lambro (IT); Fulvio Crivellaro, Arese (IT); Gabriele Genovese, Saronno (IT)

(72) Inventors: Stefano Tubaro, Novara (IT); Angusto Sarti, Seregno (IT); Marco Tagliasacchi, Carate Urio (IT); Fabio Antonacci, Ponte Lambro (IT); Fulvio Crivellaro, Arese (IT); Gabriele Genovese, Saronno (IT)

(73) Assignee: TECHNOGYM S.P.A., I-47035 GAMBETTOLA (IT)

(21) Appl. No.: 13/980,991

(22) PCT Filed: Jan. 30, 2012
(86) PCT No.: PCT/IB12/50410

§ 371 Date: Jul. 22, 2013

(30) Foreign Application Priority Data
Feb. 4, 2011 (IT) MO2011A000013

(51) Int. Cl. G01B 5/00

(52) U.S. Cl. CPC G01B 5/00
USPC 702/41

(57) ABSTRACT

An apparatus for locating the point of impact of a body on a surface comprises detecting means (12; 12a, 12b, 12c, 12d) adapted to detect pressure waves generated by the interaction of said body with said surface, and a processing unit (15) operatively connected to said detecting means (12; 12a, 12b, 12c, 12d); the detecting means (12; 12a, 12b, 12c, 12d) and the processing unit (14, 15) are configured for detecting and processing power values associated with said pressure waves so as to calculate the position of said point of impact as a function of the aforementioned power values. Also described is the related method.

### TECHNICAL FIELD

This invention relates to an apparatus and a method for locating the point of impact of a body on a surface. The invention may be used for diverse applications and/or in several sectors, for example in the biomedical field, in the sphere of sports or entertainment, in the gym sector and in other sectors. In one possible application, the apparatus may be generically built into a platform, a footboard or a belt and, in particular, into a treadmill, allowing information about the user, including the position of each the user's feet to be collected in a manner which is at once simple and reliable.

### BACKGROUND ART

Treadmills of several types are known in the prior art which are capable of detecting the position of a user on the moving belt. In a first type of treadmill, pressure sensors distributed over a surface under the belt are used. To achieve an acceptable level of precision in locating the zone of contact of each foot, a large number of sensors must be provided, with obvious disadvantages in terms of structural complexity and production cost.

In a second type of treadmill, two sensors are mounted under the moving belt. The sensors are sensitive to the wavefronts produced by the impact of the feet on the treadmill. A specific calculating unit processes the differences between the times the two sensors are reached by the acoustic wavefronts, thus estimating the position of the impact zone through complex algorithms which require very high computing power and make this type of treadmill rather expensive.

In another type of treadmill, acoustic sensors are used which are capable of detecting the sound curve associated with the impact of the foot on the belt. A specific calculating unit compares the sound curve detected by the sensors with a plurality of sound curves previously stored in the unit itself, each corresponding to a specific impact situation which specific belt boundary conditions are associated with.

Obviously, to achieve a good level of precision, it is necessary to perform a highly painstaking, and hence costly, mapping procedure which requires skilled personnel and, moreover, must be performed on every single treadmill, since mapping is affected by the micro and macro structural mechanical properties of the sound propagation means, which vary from case to case. Furthermore, measurement is affected by even a small geometrical and/or structural variation of the platform which interacts with the feet, for example on account of wear or a crack caused by extended use, or the presence of another object on the platform, thus diminishing the reliability of the measurement and the precision of the data obtained.

### AIM OF THE INVENTION

One aim of this invention is to improve the prior art apparatuses and methods for locating the point of impact of the foot on a treadmill.

Another aim of the invention is to provide a method for locating the point of impact of a body on a surface in a manner which is at once simple and reliable and a related apparatus which is structurally simple and inexpensive to make.

According to a first aspect of it, the invention provides an apparatus for locating the point of impact of a body on a surface as defined in claim 1.

According to a second aspect of it, the invention provides a method for locating the point of impact of a body on a surface as defined in claim 17.

The invention makes it possible to overcome all the above mentioned drawbacks of the prior art.

### BRIEF DESCRIPTION OF THE DRAWINGS

The invention can be better understood and implemented with reference to the accompanying drawings which illustrate non-limiting example embodiments of it and in which:

FIG. 1 is a side view of a treadmill having the apparatus according to the invention built into it;

FIG. 2 is a top view of the treadmill of FIG. 1;

FIGS. 3 and 4 schematically illustrate one possible configuration of detecting means included in the apparatus according to the invention, the apparatus being included in a treadmill;

FIG. 5 is a block diagram associated with the apparatus and method according to the invention;

FIGS. 6 to 8 are further block diagrams representing the calibration of different quantities associated with the apparatus and method according to the invention;

FIG. 9 is yet another block diagram associated with the displaying of quantities supplied by the apparatus and method according to the invention.

### DETAILED DESCRIPTION OF THE PREFERRED EMBODIMENTS OF THE INVENTION

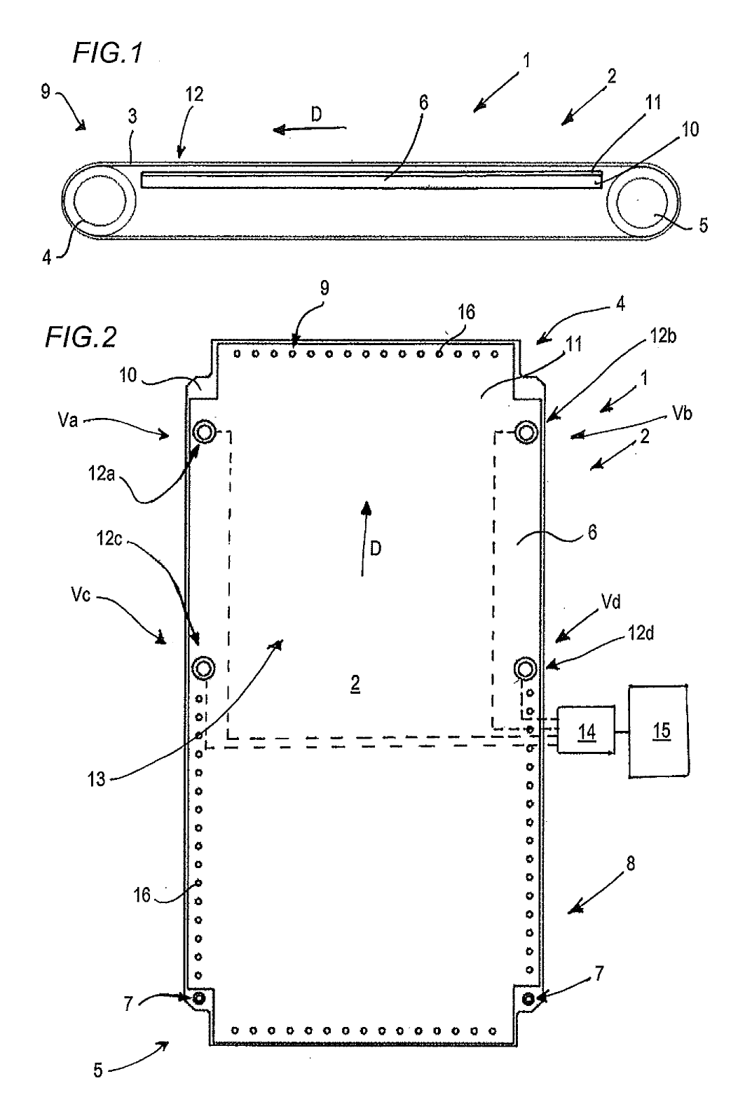

Described with reference to the accompanying drawings is an apparatus 1 and a method suitable for diverse applications and usable in several sectors, as for example in the biomedical field, in the sphere of sports or entertainment, in the gym sector and in other sectors. FIGS. 1 to 4 schematically illustrate an apparatus 1 according to the invention which allows location of the point of impact of a body on a surface. More specifically, the drawings show a treadmill 2 having a built-in apparatus 1 which makes it possible to estimate several characteristics or quantities describing a walk or run.

The apparatus 1 may be built into a platform, footboard or belt or it may, more generally speaking, be associated with a surface to enable information about the impact of a body on the surface itself to be collected in a manner which is at once simple and reliable. The invention may be used in professional gym machines, in home gym machines, in biomedical machines and, more generally speaking, in touch interface devices for diverse applications.

The apparatus 1, in the specific but non limiting application described hereinafter with reference to FIGS. 1 to 7, that is to say, in the context of a treadmill 2, besides locating the point of impact of each foot, makes it possible to monitor and/or obtain other information, including step frequency or rate, for example in steps per minute, step or stride length, stride width, intensity of foot impact on the sliding belt of the treadmill 2, possible asymmetry of foot interaction with the belt, due for example to a leg pain, the presence or absence of a user on the belt, the type of shoes used, weight imbalance towards the heel or metatarsal region of the sole of the foot and other information.

FIG. 1 shows a treadmill 2 in which the apparatus 1 is included. A sliding belt 3 is trained around a power drive roller 4 and a driven roller 5 mounted respectively at a front zone and a rear zone relative to an advancing direction D of the belt 3.

Between the power drive roller 4, the driven roller 5 and the belt 3 there is a board 6 which acts as a substantially rigid platform 6 adapted to support the user in contact with the belt 3. The belt 3 is made of a material which is acoustically transparent to the vibrations from the platform 6.

A rear portion 8 of the platform 6 is mechanically connected to a supporting frame of the treadmill 2 through removable fastening elements, such as a pair of screws 7, located on opposite sides at one end of the belt 3. The screws 7 are located closer to the driven roller 5.

A front portion 9, and/or a middle portion of the platform 6, on the other hand, rests on suspension elements, for example cylindrical rubber elements, adapted to reduce or damp the vibrations produced by the user's running or walking.

The platform 6 is of a composite type and comprises two layers, in particular, a thicker lower layer 10 and a thinner upper layer 11 which is stiffer and smoother so as to reduce the friction due to the sliding of the belt 3 on it. The lower layer 10 is made, by way of a non-limiting example, of MDF (medium-density fibreboard), while the upper layer 11 is made of resin-coated cellulose. Of course, other types of materials may be used, provided they are suitable for this application.

The upper layer 11 is well glued to the lower layer 10 to prevent the two layers from producing unwanted resonance. For this purpose, between the lower layer 10 and the upper layer 11 there is interposed a further thin layer of rubber solution glue which is sprayed onto the two surfaces placed in contact with each other. Suitable fastening elements, such as further screws 16, are provided for further securing the upper layer 11 to the lower layer 10.

Detecting means 12 are provided which are included in the apparatus 1 and which are configured to detect an interaction of the user's foot with a surface it comes into contact with, in this case with the belt 3, and hence with the platform 6.

More specifically, the detecting means comprise a plurality of acoustic or contact vibration sensors 12 capable of picking up foot impact on the platform 6. In the non-limiting example embodiment referred to here, there are four piezoelectric sensors 12, more specifically denoted by the reference characters 12a, 12b, 12c, 12d, located near respective corners Va, Vb, Vc, Vd of a substantially rectangular or square interaction area 13 within which the user's feet normally make impact against the belt 3 and hence against the platform 6. The sensors 12 may be applied for example by means of two-sided adhesive tape. The number and arrangement of the sensors 12 are non-limiting and may be chosen according to specific requirements or desired applications.

The apparatus 1 also comprises a conversion device 14, such as an analogue-to-digital conversion card operatively connected to the sensors 12. In the non-limiting example embodiment described, the conversion device 14 may be a 4-channel audio card connected to the sensors 12 by shielded cables to prevent interferences from the electric motor of the treadmill 2 or from other electric or electronic components.

The apparatus 1 further comprises a calculating device 15, such as a personal computer or a digital signal processor (DSP), operatively connected to the conversion device 14.

The sensors 12 are applied to the board 6 under the sliding belt 3 so as to pick up the vibrations produced by foot impact. The signals are acquired and processed in real time in order to estimate the position of the point of impact and other running or walking parameters, as mentioned above.

The analysis of the signal acquired by the vibration sensors, together with the estimate of the point of impact makes it possible, as already mentioned, to determine other information, including stride length, step frequency and asymmetry of the impact force.

The vibration signals acquired through the sensors 12 are converted into digital signals by the conversion device 14.

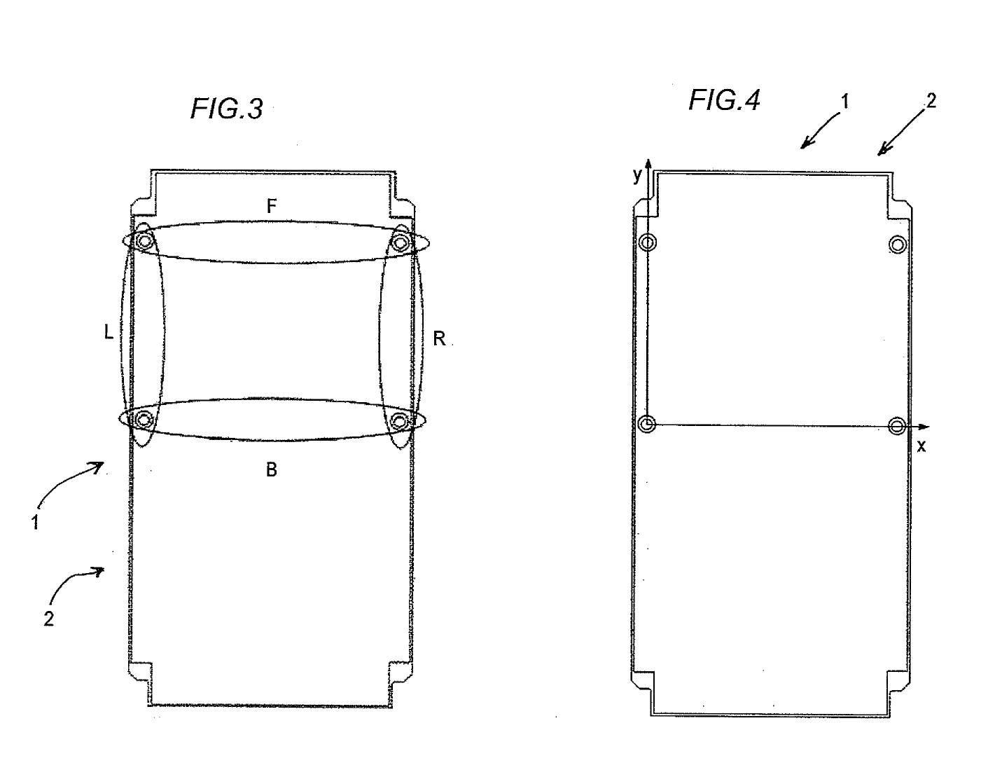

The algorithm adopted for detecting the user's steps is based on the joint observation of the power of the signals associated with the individual sensors 12. The algorithm is based on analysis in pairs of the power envelopes of the signals acquired by the sensors. In other words, a comparison is made of the power detected by the respective sensors which define a pair of adjacent sensors. FIG. 3 schematically illustrates all the sensor pairs. More specifically, a front pair F, a rear pair B, a left-hand side pair L and a right-hand side pair R are shown. Thus, each sensor 12 is associated with two possible pairs of adjacent sensors, as shown in FIG. 3.

The digital signal from each sensor 12 is converted into the discrete time domain by the analogue-to-digital conversion (ADC) device 14 at a sampling frequency of, by way of a non-limiting example, 48000 Hz for processing by the calculation device 15.

Each signal is divided into intervals, or windows, which do not overlap and each of which is composed of 512 samples (corresponding to a time interval of 10.66 ms), or 1024 samples (corresponding to a time interval of 21.33 ms). The number of samples is chosen according to the computing power available in the calculating device 15.

As described above, on one side of it, the platform 6 is fixed to the frame of the treadmill 2 by the screws 7 and on the other rests on rubber damping elements. This configuration tends to produce low-frequency vibrations which are picked up by the sensors 12. For this reason, the signals acquired are filtered by a “high pass” filter with a cutoff frequency of 10 KHz.

The power Pₗ(i) of the high pass filtered signal s_{l,i}(n) from the i-th sensor and related to the l-th window is calculated as follows:

$${P}_{l} ( i ) = 10 {log}_{10} ( {\sum }_{n = 1}^{N} {{s}_{l , i} ( n )}^{2} ) + 10 {log}_{10} ( {C}_{l} )$$

where “n” indexes the sample within the window and Cₗ is a value which compensates for possible differences in the signal amplitude in the individual channels. The description of the step locating procedure continues as follows. The peaks are extracted from the power envelope Pₗ(i), the local maximum values of the power profiles which exceed a preset threshold “t” for all the sensors 12 are chosen, and, from the power peaks extracted, the front power, right-hand side power, left-hand side power, and rear power are calculated by summing the contribution of the single sensor to the respective sensor pairs, as indicated in the following formulas:

P_{R}(i)=P_{RF}(i)+P_{RB}(i)

P_{L}(i)=P_{LF}(i)+P_{LB}(i)

P_{F}(i)=P_{RF}(i)+P_{LF}(i)

P_{B}(i)=P_{RB}(i)+P_{LB}(i),

where the subscripts RF, RB, LF, LB refer to the sensors located at the front-right, rear-right, front-left and rear-left positions, respectively.

The amplitudes of the peaks P_{R}(i) and P_{L}(i) allow determination of the lateral position of the point of foot impact, while the amplitudes of the peaks P_{B}(i) and P_{F}(i) allow determination of the longitudinal position of the foot, that is, the position along the advancing direction D.

The time sequence of the peaks allows information regarding the step rate to be obtained. Knowing the speed of the belt allows step length to be calculated. Further, by monitoring the steps of the right foot and of the left foot it is possible, based on variations of foot positions on the platform, to estimate asymmetry of the user's weight distribution on the feet.

To be able to locate the step, it is necessary to define a law for the drop in the amplitude of a wavefront during propagation. Experiments showed that the power drop follows an exponential law according to the following formula:

P(d)=aexp(−kd),

where “a” and “k” are two constants and d” is the distance between the touch or impact point and the detection point, that is, the zone where the sound wave is detected.

By dividing the power detected at the distances “d₁” and “d₂” the following is obtained:

P(d₁)/P(d₂)=exp{−k(d₁−d₂)}.

It should be noted that the amplitude constant “a” is cancelled out by the mathematical division operation and must not therefore be found.

The model proposed above for the power drop is used implicitly for locating the step. More specifically, the right/left position of the foot is obtained from the following relation:

x_{F}(i)=[P_{L}(i)−P_{R}(i)−x_{RL}/2]/x_{RL},

where x_{RL} is the power ratio difference, expressed in a logarithmic scale, between the right- and left-hand pairs when the user is on a zone more to the right and a zone more to the left of the platform 6, respectively. All the quantities are expressed in a logarithmic scale.

Similarly, the front/rear position relative to the step advancing direction D is given by the following formula:

y_{F}(i)=[P_{B}(i)−P_{F}(i)−y_{FB}/2]/y_{FB}.

As in the previous case, all the quantities are expressed in a logarithmic scale.

### Calibrating the Apparatus:

In order to allow it to locate the steps, and hence the user, the apparatus must first be calibrated in order to compensate for possible differences in the amplitudes of the signals picked up by the sensors, by estimating the parameters C_{FL}, C_{FR}, C_{BL}, C_{BR}, necessary to calculate the power “felt” by each sensor.

To perform calibration, the user must strike the platform in the middle of the interaction area 13 at whose corners the four sensors 12 are situated. The point struck is equidistant from all the sensors 12 and thus the amplitudes of the signals associated with the four sensors 12 are assumed to be equal. The parameters C_{FL}, C_{FR}, C_{BL}, C_{BR}, are calculated in such a way that the deviation of the amplitude between the different sensors is compensated.

### Detecting the User:

Detecting the user involves calculating the power envelope in the same way as for locating the impact point.

In particular, the power envelope is calculated for the signals from the sensors 12. More specifically, the signals are used to detect the presence of the user as they are on reaching the sensors, without using the filter which is used, instead, to locate the user.

The power envelopes P_{R}(i) and P_{L}(i) are calculated in the same way as for locating the steps but in this case without filtering the signals. The total power envelope is calculated by summing the individual power envelopes as follows:

P(i)=P_{R}(i)+P_{L}(i)

It may be noted that when the user is present on the platform 6 and is performing a fitness activity, the power envelope presents regular, almost periodic peaks. A fundamental aspect of this user detection algorithm is the setting of a threshold value for the power P(i) and the comparison of the latter with that threshold value: if the power envelope contains successive peaks which exceed that threshold value and which are periodic, then the presence of the user on the platform 6 is acknowledged, and hence detected, together with other quantities describing the movement of the user on the platform 6. It should also be noted that the threshold value is used to distinguish the vibrations produced by the user's steps from those due to background noise produced by the sliding of the belt 3, by the electric motor and by the rollers 4 and 5. Since the level of the background noise varies as a function of the speed selected by the user, there is a function which suitably adjusts the threshold value to adapt it to the specific value of treadmill 2 speed.

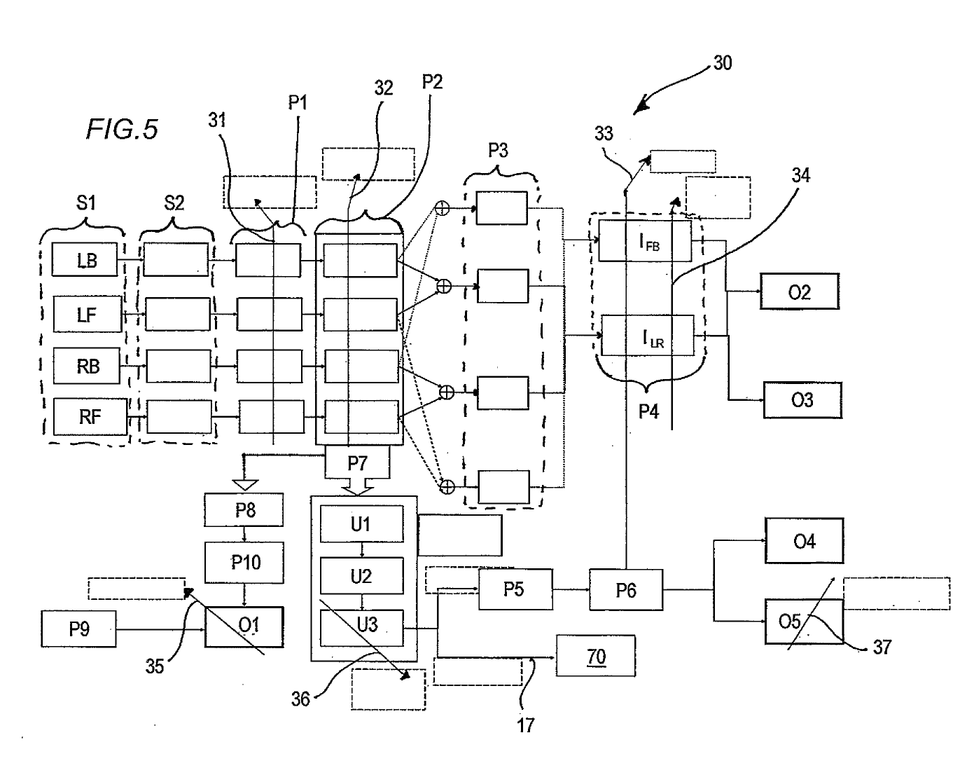

FIGS. 5 to 9 are block diagrams representing the apparatus and method according to the invention.

FIG. 5 shows a first block diagram representing the normal operation of the apparatus 1. A first group, of blocks S1 represents the step of acquiring the signals from the respective sensors 12, showing in particular the signals LB, LF, RB, RF from the rear left sensor, the front left sensor, the rear right sensor and the front right sensor, respectively. The signals leave the first group of blocks S1 at a frequency of 44100 Hz.

Downstream, of the first group of blocks S1 there is a second group of blocks S2 representing the step of filtering the signal in the pass band from 10000 to 20000 Hz. This step might not be performed, depending on the operating configuration of the apparatus 1. The second group of blocks S2 receives as input the signals from the first group of blocks S1 and produces as output the filtered signals at a frequency of 44100 Hz.

Downstream of the second group of blocks S2 there is a third group of blocks P1 representing the step of calculating the energy of the windowed signal in a logarithmic scale. The signals from the second group of blocks S2 (if used) or from the first group of blocks S1 are received as input. Provided as output is the energy level of the current window calculated according to the following formula:

$$Output = 10 {log}_{10} ( {\sum }_{1}^{N} {s ( n )}^{2} )$$

Provided as external parameters are the sensor 12 gains acquired during the calibration procedure.

The signals from the third group of blocks P1 pass to a fourth group of blocks P2 where the energy associated with the noise produced by the movement of the belt 3 and by the electric motor is removed.

The output energy value is calculated according to the following formula:

Output=10 log₁₀(10^{Input/10}−Noise level)

The noise level associated with the movement (rotation) of the belt 3 and with the electric motor is a parameter which comes from a block diagram of noise level calibration described below.

A fifth group of blocks P3 receives as input pairs of signals (left, right, front and rear) from the fourth group of blocks P2 to provide as output the energy level associated with those signal pairs, according to the following formula:

Output=10 log₁₀(10^{Input/10}+10^{Input2/10})

Downstream of the fifth group of blocks P3 there is a sixth group of blocks P4 representing the step of interpolating the energy pairs from the fifth group of blocks P3 in order to locate the steps. Interpolating starts only if the presence of a foot on the platform 6 is detected.

The sixth group of blocks P4 includes a step I_{FB} of front-rear interpolation, that is, of locating longitudinally along (“y” coordinates) or parallel to the advancing direction D, and a step of I_{LR} of left-right interpolation, that is, of locating laterally of (“x” coordinates) or transversally to the advancing direction D. Received as input are the front-rear or left-right energy values coming from the fifth group of blocks P3 and provided as output are the respective energy values (expressed in db) according to the following equations:

Output left−right=[Energy right−Energy left−(runPad.1+runPad.r)/2)/(runPad.r−runPad.1)]

Output front−back=−[Energy front−energy back−(runPad.f+runPad.b)/2)/(runPad.f−runPad.b)]

where the terms “runPad.1”, “runPadr”, “runPad.b”, “runPadf”—which are the energy values of the left, right, front and rear sensor pairs when the runner is on the left, the right, the rear and the front zone of the belt, respectively—represent parameters from the block diagram of belt calibration described below.

The data from the sixth group of blocks P4 are processed in a step represented by the block O2, which provides the location of the impact point.

As may be seen in the diagram, there is a step O3 in which the data from the step of left-right interpolation are received in order to calculate the stride width, expressed as an absolute value of the difference between the x-coordinates of two successive steps.

A block P7 represents the step of calculating the total energy, in a natural scale, of the signals as the sum of the energy values of the single sensors 12.

A block P8 receives as input the last two energy samples of the left and right steps. The energy values of the last two steps (left and right) are stored in order to determine the energy imbalance, as in the block P10 further downstream. More specifically, the block P10 represents calculation of the difference (in db) between the left step and the right step in order to determine a possible imbalance of the user on the platform 6.

The block P9 represents the step of identifying whether the user has struck the platform 6 with the left foot or with the right foot. The data received as input come from the block O2. If the last impact point is on the left of the one preceding it, it is identified as left step. If it is further to the right, it is identified as right step.

The data from the block P10 and from the block P9 merge in a block O1 representing the step of identifying possible imbalance in the impact force between left foot and right foot. If the impact force of the left foot has exceeded that of the right foot by more than the acceptance threshold, then a greater impact force of the left foot is acknowledged. If the impact force of the right foot has exceeded that of the left foot by more than the acceptance threshold, then a greater impact force of the right foot is acknowledged. The block O1 has as an external parameter the information item provided by the block P9, that is, the one relating to acknowledgement of right or left foot.

Downstream of the block P7 there are, in sequence, a block U1, a block U2 and a block U3, described below.

The block U1 represents the step of calculating the moving average of the energy in the last windows. This step serves to remove possible external noise sources. Received as input is the total energy value from the block P7, and provided as output is the moving average value, calculated in a natural scale with the following formula:

$$output = 1 / N {\sum }_{1}^{N} p ( n )$$

The block U2 receives the data item provided by the block U1 and provides as output a buffer of the last samples from the block U1. This step serves to provide the energy associated with the moving average with a delay for a few samples of the windowed energy so as to infer whether a further step is present or to determine whether the user is no longer on the treadmill 2.

The block U3 represents the step of identifying whether or not the user is still on the treadmill 2. The block U3 has as external parameters the speed of the treadmill 2 and the total noise threshold.

The data item from the block U2 is received as input and significant peaks, if any are identified and determined above the preset threshold are provided as output. If there are such peaks, the presence of the user on the belt 3 is acknowledged. If there are no such peaks, on the other hand, the user is considered to be absent.

Downstream of the block U3 there is a block P5 which operates only if the user is present on the treadmill 2 and which receives as input the total energy from the block P7 to provide as output the time instant in which the foot comes into contact with the platform 6. That time instant is the instant at the end of the energy ramp up when the ramp is considered significant. The aim of the block P5 is to identify the presence or absence of a peak in the signal energy. If a peak is present, its time instant is used to determine the time position of the step according to what is provided by a block P6 located further downstream in the diagram.

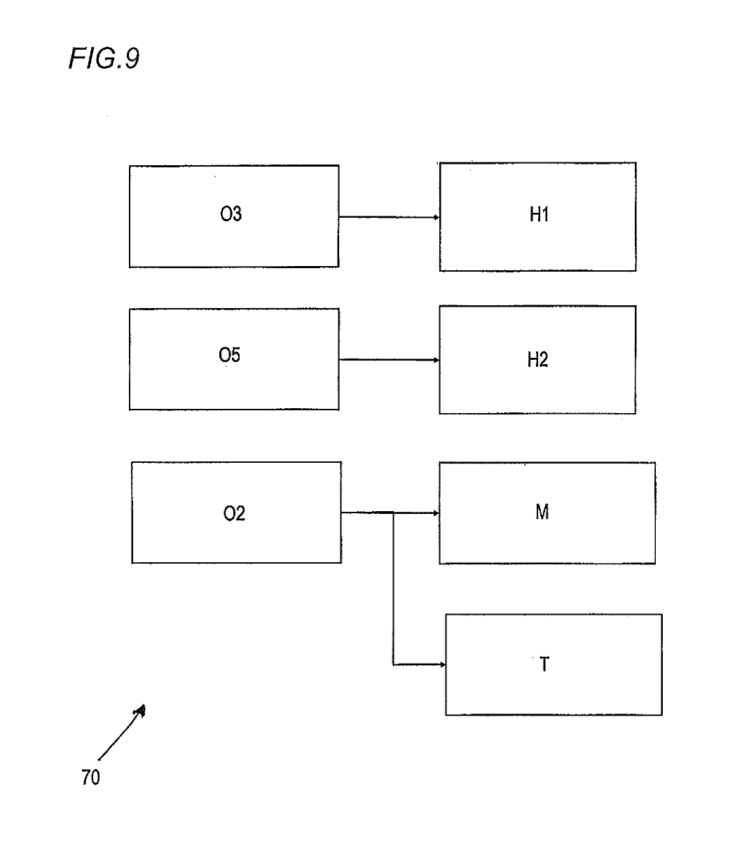

According to the algorithm, if the user steps off the treadmill 2, all the information provided downstream of the block U3 merge, as shown by the line 17 directly into a fifth block diagram 70 which summarizes the information and which is described with reference to FIG. 9.

The block O4, downstream of the block P6, represents the step of calculating the instantaneous step frequency. Two time instants associated with two consecutive steps are received as input and the output is a value determined by the following formula:

Output=1/(Time instant of the last footstep−Time instant of the previous footstep)

The block O5 represents the step of calculating the stride length as the difference between the “y” coordinates of the last two impact points on the belt 3 and taking into account the sliding motion of the belt 3 under the user's feet.

The data items relating to the time instants of two successive impacts are received as input and provided as output is the stride length calculated as the product of belt 3 speed (which is an external parameter taken into account) by the difference between the two aforementioned time instants.

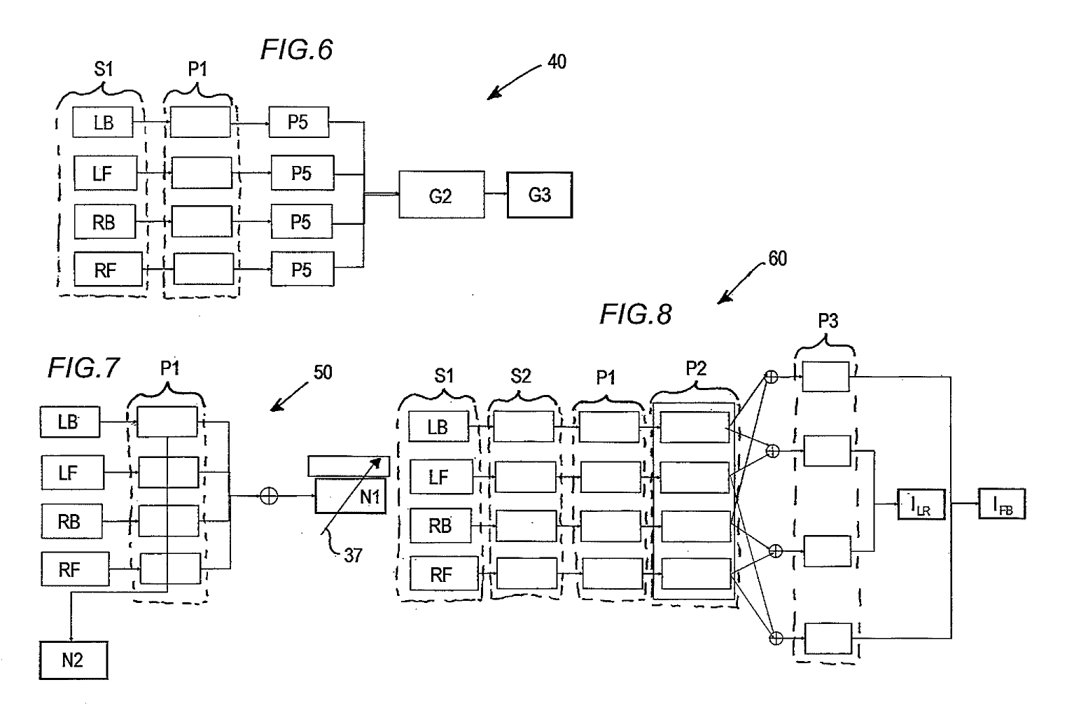

In the first block diagram 30, one or more blocks have arrow lines 31, 32, 33, 34, 35, 36, 37 going through them to indicate that the steps associated with the selfsame blocks are activated and/or controlled by predetermined parameters as well as by the input data received. In particular, the arrow line 31 indicates that the steps of the blocks P1 are influenced by the gain values obtained in a gain calibration step shown in a second block diagram 40 described below with reference to FIG. 6.

The arrow line 32 indicates that the steps of the blocks P2 are influenced by the noise levels obtained in a noise level calibration procedure shown in a third block diagram 50 described below with reference to FIG. 7.

The arrow line 33 indicates that interpolation performed in the steps represented by the blocks I_{FB} e I_{LR} is started only when a step on the platform is identified.

The arrow line 34 indicates that the respective blocks I_{FB} e I_{LR} are influenced respectively by the parameters from a procedure of calibrating the energy values associated with the sliding belt 3 in motion, that is to say, the energy values of the left, right, front and rear sensor pairs when the runner is on the left, the right, the rear and the front zone of the belt, respectively. These parameters are from a fourth block diagram 60 of belt calibration, described below.

The arrow line 35 indicates that the block O1 is influenced by an external parameter represented by the information item provided by the block P9, that is, the one relating to acknowledgement of right or left foot.

The arrow line 36 indicates that the block U3 is influenced by external parameters such as the speed of the treadmill 2 and the total noise threshold.

The arrow line 37 indicates that the block O5 is influenced by the speed of the treadmill 2 as external parameter. The blocks drawn with the thicker lines indicate that the data they provide are also used in other block diagrams.

FIG. 6 shows the second block diagram 40 relating to the sensor gain calibration procedure.

Many of the blocks represented have already been described with reference to the first block diagram 30 and are therefore denoted by the same reference characters and will not be further described. Downstream of the blocks P2, which detect the peaks associated with the different sensors 12, there is a block G2 whose purpose is to receive as input the signals from the blocks P5 in order to identify and thus provide as output the highest of the four peaks present in these signals.

The block G3, located downstream of the block G2, represents the step of calculating sensor gain used to equalize the energy values. The output data item is calculated using the following formula:

Gain=max peak/peakᵢ

The third block diagram 50, shown in FIG. 7, relates to noise level calibration and, in addition to the blocks LB, LF, RB, RF and P1, already described, comprises a block N2. The purpose of the block N2 is to calculate the noise produced by the treadmill 2 (in particular by the belt 3, the electric motor and other components) in order to compensate it during normal operation.

Lastly, there is a block N1 whose function is to calculate the total threshold as the noise level given by the sum of the energy values of the individual signals. In other words, the total noise level is provided as its output.

FIG. 8 shows the fourth block diagram 60 representing calibration of the treadmill 2, this diagram being included, and thus already described, in the first block diagram 50, shown in FIG. 5.

FIG. 9 shows the fifth block diagram 70, which is a summary diagram, showing the information provided by the apparatus and method according to the invention.

This figure shows the blocks O2, O3 and O5, described above. The data from the blocks O3 and O5 are processed to provide, for example, graphical representations such as histograms H1 and H2 relating to the values of stride width and stride length, respectively.

The data from the block O2 are processed to provide graphical representations such as a two-dimensional map M of the contact or impact points of the feet on the platform 6 and a trajectory T followed by the user during the motor activity. The apparatus 1, and hence the treadmill 2 it is built into, may be equipped with a graphical interface, such as a liquid crystal display or the like, adapted to display the above mentioned information.

The apparatus and the method described above achieve the preset aims. In particular, they not only allow overall running parameters such as step speed and rate to be obtained but they also make it possible to obtain accurate positional measurements of the runner's feet and to collect statistics regarding step distribution and to detect asymmetry and step irregularities which might indicate motor problems.

Variants and/or additions are possible to the invention as described above and illustrated in the accompanying drawings. In particular, the configuration and dimensions of the device may be modified as desired according to the many applications the device may be used for. Several elements of the apparatus may be substituted for other, technically equivalent elements without thereby departing from the scope of the invention. Moreover, the material used to construct the apparatus may be of any type, depending on requirements and the state of the art, provided they are suitable for the specific use they are intended for.

1. An apparatus for locating the point of impact of a body on a surface, comprising detecting means (12; 12a, 12b, 12c, 12d) adapted to detect pressure waves generated by the interaction of said body with said surface, and a processing unit (15) operatively connected to said detecting means (12; 12a, 12b, 12c, 12d), wherein said detecting means (12; 12a, 12b, 12c, 12d) and said processing unit (14, 15) are configured for detecting and processing power values associated with said pressure waves so as to calculate the position of said point of impact as a function of said power values.

2. The apparatus according to claim 1, and comprising a supporting structure (6) on which said detecting means (12; 12a, 12b, 12c, 12d) are positioned to be near said surface.

3. The apparatus according to claim 2, wherein said detecting means comprise a plurality of acoustic or vibration contact sensors (12; 12a, 12b, 12c, 12d) which are sensitive to vibrations or sounds generated by the impact of said body on said surface and which are positioned in several distinct zones (Va, Vb, Vc, Vd) of said supporting structure (6), said processing unit (14, 15) being configured for obtaining and comparing with each other amplitude values associated with the vibrations or sounds picked up respectively by the single sensors (12a, 12b, 12c, 12d) in the respective zones (Va, Vb, Vc, Vd) to determine the position of said point of impact with respect to such sensors (12a, 12b, 12c, 12d) and thus locate said point of impact on said surface.

4. The apparatus according to claim 2, wherein said supporting structure comprises a platform (6) in which are defined a thicker lower layer (10) and a thinner upper layer (11) that is stiffer and smoother than said lower layer (10) and having a reduced friction coefficient, said detecting means (12; 12a, 12b, 12c, 12d) being positioned on said upper layer (11).

5. The apparatus according to claim 4, wherein said detecting means (12) comprise four acoustic or vibration sensors (12a, 12b, 12c, 12d) located at the corners of an interaction area (13) of said platform for receiving the action of said body.

6. The apparatus according to claim 4, wherein said lower layer (10) comprises a panel of medium density fibre (“MDF”), and said upper layer (11) is made of resin cellulose, said lower layer (10) and said upper layer (11) being fixed together by a further thin layer of sprayed rubber solution glue and by mechanical fastening elements (16).

7. The apparatus according to claim 4, wherein a first end zone (8) of said platform (6) is fixed to a supporting frame by further fastening elements (7), and a second end zone (9) and/or a central zone of said platform (6) rests on elastic suspension elements, adapted to reduce and damp the vibrations produced by said body.

8. The apparatus according to claim 1, further comprising an analogue-to-digital conversion device (14), suitable for receiving and converting from analogue to digital the signals coming from said detecting means (12; 12a, 12b, 12c, 12d).

9. The apparatus according to claim 8, wherein said analogue-to-digital conversion device comprises a four-channel audio card (14), connected to respective sensors (12a, 12b, 12c, 12d) by shielded cables to prevent electrical noise; wherein said lower layer (10) comprises a panel of medium density fibre (“MDF”), and said upper layer (11) is made of resin cellulose, said lower layer (10) and said upper layer (11) being fixed together by a further thin layer of sprayed rubber solution glue and by mechanical fastening elements (16), and wherein said detecting means (12) comprise four acoustic or vibration sensors (12a, 12b, 12c, 12d) located at the corners of an interaction area (13) of said platform for receiving the action of said body.

10. The apparatus according to claim 1, further comprising a calculating device (15), such as a personal computer or a digital signal processor (DSP), operatively connected to said conversion device (14) to process the signals coming from said detecting means (12; 12a, 12b, 12c, 12d).

11. The apparatus according to claim 1, wherein said detecting means comprise piezoelectric sensors (12; 12a, 12b, 12c, 12d).

12. The apparatus according to claim 1, including said supporting structure (6), said supporting structure (6) being configured to be mounted on a treadmill (2) for receiving and supporting a sliding belt (3) and for interacting with the feet of a user.

13. The apparatus according to claim 12, and further comprising a graphic interface for displaying at least one of the following pieces of information: position of the point of impact, step frequency, stride length and width, asymmetry of the impact force, impact intensity of each foot.

14. A gym machine comprising an apparatus according to claim 1.

15. The gym machine according to claim 14, comprising a treadmill (2).

16. The gym machine according to claim 14, wherein said apparatus (1) is configured for detecting the presence of a user on a footboard (6) included in said gym machine or treadmill (2) according to said power values which are detected by said detecting means (12; 12a; 12b, 12c, 12d) and processed by said processing unit (14, 15).

17. A method for locating the point of impact of a body on a surface, comprising the steps of:
detecting the pressure waves generated by the interaction of said body with said surface; and
processing said pressure waves to obtain the position of said point of impact,
wherein said detecting and processing steps comprise detecting and processing power values associated with said pressure waves so as to calculate the position of said point of impact as a function of said power values.

18. The method according to claim 17, wherein said detecting step comprises detecting in a plurality of zones (Va, Vb, Vc, Vd) of said surface vibrations or sounds generated by the impact of said body on said surface, and wherein said processing step comprises calculating amplitude values of said vibrations or sounds associated with each of said zones (Va, Vb, Vc, Vd) to determine the position of said point of impact on said surface by comparing said amplitude values with each other.

19. The method according to claim 17, wherein said detecting step comprises converting into digital signals said vibrations or sounds, and said calculating step comprises analysing and comparing the power, or the amplitude of the signals picked up at the respective zones (Va, Vb, Vc, Vd).

20. The method according to claim 19, wherein said analysing step comprises comparing in pairs the power envelopes of the signals associated with respective pairs of zones (Va, Vb, Vc, Vd) which are adjacent to one another.

21. The method according to claim 17, further comprising steps of filtering signals associated with said pressure waves in a pass band from 10000 to 20000 Hz, calculating the energy of said signals in a logarithmic scale, and removing energy components associated with noise not generated by said body.

22. The method according to claim 17, wherein energy values are calculated that are associated with signal pairs of said pressure waves which are picked up in respective pairs of zones (Va, Vb; Va, Vc; Vb, Vc; Vc, Vd), said pairs of zones (Va, Vb; Va, Vc; Vb, Vc; Vc, Vd) defining respectively a front region, a left lateral region, a right lateral region, a rear region on said surface, so as to determine the position of said point of impact along a transverse direction (X) with respect to an advancing direction (D) of said body on said surface, and/or along a longitudinal direction (Y) with respect to said advancing direction (D).

23. The method according to claim 22, wherein pairs of said energy values are interpolated to determine a coordinate (Y) of said position with respect to said front region and said rear region, and a coordinate (X) of said position with respect to said left lateral region and said right lateral region.

24. The method according to claim 17, wherein said body is defined by each foot of a user, and said surface is included in a treadmill (2), wherein said method comprises determining, from the analysis of the acquired signals and from the calculated position, at least a further piece of information such as stride length and width, and/or step frequency, and/or asymmetry of the force of impact, and/or impact intensity of each foot.

25. The method according to claim 17, for detecting the presence of a user on a footboard (6) of a treadmill (2) on the basis of the detection and processing of said power values.

26. A computer programme, comprising portions of software code for running the method according to claim 17 when said programme is run on said computer or on said calculating device (15).

27. A means which is readable by a computer or by said calculating device (15), comprising a programme as defined by claim 26.
